(19) United States
(12) Patent Application Publication
(10) Pub. No.: US 2011/0083691 A1
(43) Pub. Date: Apr. 14, 2011

(54) VIBRATORY APPARATUS

(76) Inventor: Mitch Junkins, Newport Beach, CA (US)

(21) Appl. No.: 12/895,714

(22) Filed: Sep. 30, 2010

Related U.S. Application Data
(60) Provisional application No. 61/249,854, filed on Oct. 8, 2009.

(51) Int. Cl. A45D 27/00; B26B 21/40; A46B 13/02; A45D 24/00; A61C 15/04

(52) U.S. Cl. 132/200; 30/45; 15/22.1; 132/322; 132/271

(57) ABSTRACT

An apparatus and a system for use with a traditional prior art hygienic device such as a straight edge shaving apparatus is provided. The improved apparatus may be utilized with known straight edge disposable shavers, for example, whereby the apparatus may be adapted to fit a plurality of different disposable shavers and may be removably attached to the shavers to give the disposable razor a vibratory effect while still keeping the cost of the disposable razor affordable to the common user. Moreover, the present invention may utilize a renewable power source in order to effectuate the vibratory effect to the handle which may be placed over the existing handle of the disposable razor device.

### PRIORITY CLAIM

This application claims priority to the earlier filed U.S. Provisional Patent Application No. 61/249,854 filed on Oct. 8, 2009.

### FIELD OF THE INVENTION

The field of the invention is for a personal use hygienic device. More specifically, the field of invention is for an adaptable apparatus that may be fitted to prior art hygienic devices such as disposable razors that may turn any such apparatus into a vibratory hygienic apparatus.

### BACKGROUND

Razors used to shave the facial and body hair of an individual have been used for a millennium. However, the effectiveness and safety of the razor has changed drastically in the last century.

Earlier prior art razors were typically constructed using open steel blades that were sharp enough to cut and/or trim the facial and body hair of an individual. Typically, these steel blades were semi-hollow blades having a first side that was sharpened and utilized on the individual to be shaved, and had a second side which was preferably more dull and was utilized to be held in place by a handling apparatus. However, one problem with steel blades is that they were prone to rusting and would have to be sharpened relatively often to keep its effectiveness. The next evolutionary step in razor technology was the use of stainless steel blades in place of regular steel blades that didn't rust and needs much less maintenance to keep its effectiveness. However, a disadvantage of the stainless steel blade is that they are expensive to produce.

Eventually, the electric razor was developed. The electric razor has an electrical component usually consisting of a rotating blade instead of a straight edge blade. The advantage of the electric razor was that it does not require accessories common to the straight edge razor, including water, soap and shaving cream. Typical prior art electric razors utilize a power source, either wall unit DC current or rechargeable power units. Additionally, because these electric razors utilize no shaving accessories, they are relatively simple to use and are much more portable than straight edge razors. Another advantage of the electric razors are their ability to massage the skin and muscle of the individual and to cut the hair at a lower location than the standard prior art straight edge razor apparatus.

However, one major problem with electric razors is the inability to be completely accurate when a user wishes to utilize it to maintain facial or body hair. It is very difficult to keep very straight lines of facial or body hair such as mustaches or goatees. The preferred shaving accessories for these individuals is still the straight edge razor.

However, a problem with straight edge razor is they do not have the same massaging and cutting ability as the electric razor because of the lack of oscillating and/or vibratory effect on the skin of the individual utilizing the razor.

There have been attempts to utilize a vibratory effect on the straight edge razor. These units have a vibratory handle incorporated into a standard straight edge shaver apparatus. These vibratory razors and/or shavers are typically a single piece construction sold to the consumer with all the necessary components to begin shaving.

Additionally, another problem that exists is many of the vibratory straight edge razors are permanent devices whereby when the blade becomes dull, the entire apparatus including the vibratory portion must be thrown away thereby costing the consumer a great deal of money for each unit, and wasting the still good vibratory unit of the razor. Therefore, a need exists for an improved vibratory handle for a shaving device whereby the vibratory handle may be adapted for use with any standard disposable shaving apparatus and may be removed from the disposable shaving apparatus, when the apparatus becomes ineffective and whereby the vibratory apparatus may be adapted to another disposable shaving apparatus when desired by a user.

### SUMMARY OF THE INVENTION

The present invention provides an apparatus and a system for use with a traditional prior art straight edge shaving apparatus or other hygienic device. Additionally, the present invention provides an improved apparatus for use with known straight edge disposable shavers whereby the apparatus may be adapted to fit a plurality of different disposable shavers and may be removably attached to the shavers to give the disposable razor a vibratory effect while still keeping the cost of the disposable razor affordable to the common user. Moreover, the present invention may utilize a renewable power source in order to effectuate the vibratory effect to the handle which may be placed over the existing handle of the disposable razor device.

Among the many different possibilities contemplated, the apparatus may allow for multiple configurations of the device to be adaptable to a plurality of disposable razors.

Additionally, in an exemplary embodiment, the apparatus may be configured to accommodate a plurality of different razor apparatuses thereby being adaptable to variety of razors for use with same.

To this end in an exemplary embodiment of the present invention, an apparatus for use in conjunction with a hygienic device, the apparatus comprising: at least an outside portion; an interior portion, contained by the outside portion, whereby the interior portion may have an opening thereon, the opening configured to receive a hygienic device; and a vibratory device, coupled to the interior portion and configured to cause the apparatus to vibrate.

In an exemplary embodiment, wherein said outside portion is configured to allow for handling by the individual.

In an exemplary embodiment, wherein said outside portion is constructed of a foam material.

In an exemplary embodiment, wherein said outside portion is constructed of plastic.

In an exemplary embodiment, wherein said interior portion has an opening thereon for receiving the handle of a straight edge shaving device.

In an exemplary embodiment, wherein said interior portion has a power means contained therein.

In an exemplary embodiment, wherein said interior portion has a renewable power source whereby the power source is a battery.

In an exemplary embodiment, wherein the apparatus may have a button contained thereon to turn the apparatus on and off.

In an exemplary embodiment, wherein the vibratory apparatus device includes a motor whereby when activated, the motor causes vibration of the apparatus which in turn causes vibration of a hygienic device when said hygienic device is attached to the apparatus by insertion into the interior portion of the apparatus.

In an exemplary embodiment, wherein the apparatus may be releasably attached to a hygienic device and whereby a button may be contained on the outside portion to allow for release and adaption of the hygienic device to the apparatus.

In an exemplary embodiment, a hygienic system comprising: an apparatus for use in conjunction with a hygienic device, the apparatus including: at least an outside portion; an interior portion, contained by the outside portion, whereby the interior portion may have an opening thereon, the opening configured to receive a hygienic device; and a vibratory device, coupled to the interior portion and configured to cause the apparatus to vibrate, a hygienic device releasably attached to the apparatus by inserting the hygienic device into the interior portion of the apparatus.

In an exemplary embodiment, wherein the hygienic device comprises a straight edge razor.

In an exemplary embodiment, wherein the hygienic device comprises a toothbrush.

In an exemplary embodiment, wherein the hygienic device comprises a flossing apparatus.

In an exemplary embodiment, wherein the hygienic device comprises a hair brush.

In an exemplary embodiment, a method for personal hygiene comprising: providing an apparatus for use in conjunction with a hygienic device, the apparatus including: at least an outside portion; an interior portion, contained by the outside portion, whereby the interior portion may have an opening thereon, the opening configured to receive a hygienic device; and a vibratory device, coupled to the interior portion and configured to cause the apparatus to vibrate. providing a hygienic device releasably attached to the apparatus by inserting the hygienic device into the interior portion of the apparatus.

In an exemplary embodiment, wherein the hygienic device comprises a straight edge razor, the method further comprising shaving using a hygienic system that includes the apparatus and the hygienic device.

In an exemplary embodiment, wherein the hygienic device comprises a toothbrush, the method further comprising brushing teeth using a hygienic system that includes the apparatus and the hygienic device.

In an exemplary embodiment, wherein the hygienic device comprises a flossing apparatus, the method further comprising flossing using a hygienic system that includes the apparatus and the hygienic device.

In an exemplary embodiment, wherein the hygienic device comprises a hair brush, the method further comprising brushing using a hygienic system that includes the apparatus and the hygienic device.

In another exemplary embodiment, it is contemplated that the apparatus may be configurable to hold any prior art straight edge razor.

In yet another exemplary embodiment, it is contemplated that the apparatus may be configured into a shape of handle.

A further exemplary embodiment contemplates that the apparatus may be constructed of a suitable material such as plastic.

In another exemplary embodiment, it is contemplated that the apparatus may be constructed of any suitable material such as metal and the like.

Further, a contemplated embodiment of the apparatus may have an outer portion and an interior portion whereby the outer portion may be adapted for use by an individual and the interior portion may accommodate the prior art straight edge razor.

Additionally, in an exemplary embodiment, the apparatus may have a outer portion whereby the outer portion may be constructed of plastic.

In yet another exemplary embodiment, it is contemplated that the apparatus may have an outer portion whereby the outer portion may have a foam and/or polyurethane surface which may be easily handled by a user.

A further exemplary embodiment of the present invention may include an apparatus for use with prior art straight edge razors wherein the device is removably attached to the razor.

Still another exemplary embodiment of the present invention may include an apparatus having an outer portion whereby the outer portion is utilized by the individual when using the razor.

A further exemplary embodiment of the present invention may include an apparatus whereby the apparatus may have a outer portion and an interior portion whereby the interior portion is defined by a open cavity adapted for reception of the existing handle of a prior art disposable straight edge razor.

In yet another exemplary embodiment of the present invention, an apparatus may be provided whereby the apparatus may have an interior portion whereby the interior portion comprises of an opening adapted to releasably attach to the handle of a shaving apparatus and may be releasable via a disconnect button on the outer portion of the apparatus.

Yet another exemplary embodiment of the present invention may include an apparatus having an outer portion and an interior portion whereby the interior portion may also include a power source.

In an exemplary embodiment of the present invention, an apparatus may be provided whereby the apparatus may have an outer portion and an interior portion whereby the interior portion may include a power source whereby the power source may be a battery, wall adapted unit or any other power source to drive a motor.

Another exemplary embodiment of the present invention may include an apparatus that may be adapted for use with prior art straight edge razors whereby the apparatus may include a small motor adapted to perform the function of vibrating the apparatus when the unit is in the “on” position.

In still another exemplary embodiment of the present invention an apparatus utilized by an individual during shaving may be provided whereby the apparatus may have a vibratory means and the vibratory means may be turned on and off by the individual when desired.

In an exemplary embodiment of the present invention, an apparatus is provided whereby the apparatus may be adapted to removably attach to a disposable razor and thereby turn each disposable razor into a vibratory razor without the need to buy a more expensive razor apparatus.

Still, in another exemplary embodiment of the present invention, an apparatus is provided whereby the apparatus may be adapted to be removably attached to a disposable razor wherein the razor is in need of disposal, the apparatus may be removed from the razor and whereby the disposable razor may be discarded and the apparatus placed on the new, replacement razor.

In yet another exemplary embodiment of the present invention, an apparatus is provided whereby the apparatus is preferably adaptable to the handle of a prior art disposable razor assembly.

Further, in another exemplary embodiment of the present invention, an apparatus for use with prior art straight edge razor is provided whereby the apparatus may provide vibratory functions to massage and stretch the skin in order to allow the razor to more effectively cut unwanted facial and body hair from the individual user.

In another exemplary embodiment of the present invention, an apparatus may be provided wherein the apparatus may be adaptable for use with a plurality of other prior art disposable devices including toothbrushes, flossing apparatus and even hair brushes.

Still a further exemplary embodiment of the present invention is to provide an apparatus that may be utilized to cause vibratory movement of a hygienic product whereby the vibratory force may be increased and/or decreased at the discretion of the individual user.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a perspective view of illustrating the apparatus in an exemplary embodiment of the present invention.

FIG. 2 is a perspective view illustrating the back side of the apparatus in the exemplary embodiment of FIG. 1.

FIG. 3 is a cross sectional view of the apparatus in the exemplary embodiment of FIG. 1.

FIG. 4 is an illustration of an example circuit in an exemplary embodiment of the present invention.

FIG. 5 is a perspective view of illustrating the apparatus in another exemplary embodiment of the present invention.

FIG. 6 is a perspective view illustrating the apparatus in the exemplary embodiment of FIG. 5.

While the invention is subject to various modifications and alternative forms, specific embodiments thereof have been shown by way of example in the drawings and will herein be described in detail. It should be understood that this invention is not limited to the particular forms disclosed, but on the contrary, the intention is to cover all modifications, equivalents, and alternatives falling within the spirit and scope of the invention.

### DETAILED DESCRIPTION OF THE PREFERRED EMBODIMENT

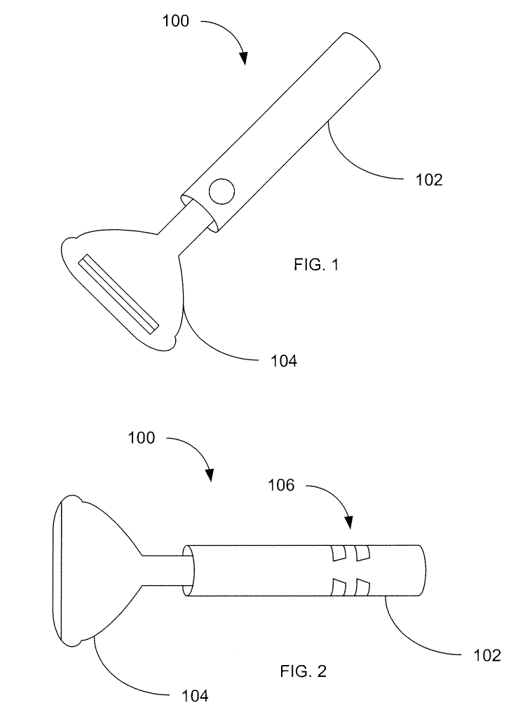

FIG. 1 is a perspective view illustrating the apparatus 102 in an exemplary embodiment. In an embodiment, apparatus 102 can be combined with a disposable shaver or portable razor 104 to form a shaving system 100.

Apparatus 102 may be used to vibrate razor 104. For example, apparatus 102 and system 100 may be configured for use with a traditional prior art straight edge shaving apparatus 106 or other hygienic device. Additionally, apparatus 102 may be adapted to fit a plurality of different disposable shavers and may be removably attached to the shavers to give the disposable razor 104 a vibratory effect while still keeping the cost of the disposable razor 104 affordable to the common user.

In an exemplary embodiment, the apparatus 102 may be configured in the shape of a handle. Such a handle may allow a user to grip and hold the apparatus while shaving, for example. It will be understood that apparatus 102 may be used in conjunction with other hygienic devices such as toothbrushes, flossing apparatus, hair brushes, etc.

Further, as illustrated in FIG. 1, the apparatus 102 may have an outer portion and an interior portion whereby the outer portion may be adapted for use by an individual and the interior portion may accommodate the prior art straight edge razor 104. This interior portion may be configured such that the prior art straight edge razors 104 when used with the apparatus 102 are removably attached to the razor 104 and thereby turn each disposable razor into a vibratory razor without the need to buy a more expensive razor apparatus.

Many different materials might be used to construct the apparatus 102. For example, a further exemplary embodiment contemplated includes an apparatus constructed of a suitable material such as plastic. Other embodiments might be constructed of plastic, metal, or any other suitable material or combination of materials to form the outer portion. A wall of the inner portion may be constructed of these same materials. Further, the inner wall of the inner portion may be the inside wall of the outer portion.

Another exemplary embodiment may be adapted to be removably attached to a disposable razor. For example, when the razor is in need of disposal because the blade is no longer sharp, the apparatus may be removed from the razor and the disposable razor may be discarded and the apparatus placed on the new replacement razor.

In yet another exemplary embodiment of the present invention, an apparatus is provided whereby the apparatus is preferably adaptable to handle a prior art disposable razor assembly. Such an assembly may include a handle and a detachable razorblade assembly. In this way the razorblade assembly may be discarded, for example, when the razor is no longer sharp. The handle of the detachable razorblade assembly may be retained and a new razorblade assembly might be attached to the handle. As such, an embodiment of apparatus 102 may be adapted to be removably attached to the handle of the disposable razor 104 assembly. The embodiment may itself form a handle that may be used to hold the combined hygienic system that includes apparatus 102 and a disposable razor assembly. Further, in some embodiments, a razorblade assembly might attach directly to an apparatus similar to apparatus 102, but that includes an attachment point extending from the apparatus that is configured to couple to one or more types of razorblade assemblies.

Further, in another exemplary embodiment an apparatus for use with prior art straight edge razor is provided whereby the apparatus may provide vibratory functions to massage and stretch the skin in order to allow the razor to more effectively cut unwanted facial and body hair from the individual user.

In an embodiment an example apparatus may be utilized to cause vibratory movement of a hygienic product whereby the vibratory force may be increased and/or decreased at the discretion of the individual user. For example, a control mechanism such as a rotary switch (not shown) might be used to increase or decrease the vibratory force of apparatus 102.

FIG. 2 is a perspective view illustrating the back side of the apparatus 102 in the exemplary embodiment of FIG. 1. The view further illustrates that some exemplary embodiments may include an apparatus 102 having an outer portion whereby the outer portion is utilized by the individual when using the razor 104. For example, it is contemplated that the apparatus 102 may have an outer portion including gripping surfaces 106. The gripping surfaces 106 may have a foam and/or polyurethane surface which may be easily handled by a user.

A further exemplary embodiment of the present invention may include an apparatus whereby the apparatus may have a outer portion and an interior portion whereby the interior portion is defined by a open cavity adapted for reception of the existing handle of a prior art disposable straight edge razor. In an embodiment of the present invention an apparatus utilized by an individual during shaving may be provided whereby the apparatus may have a vibratory means whereby the vibratory means may be turned on and off by the individual when desired.

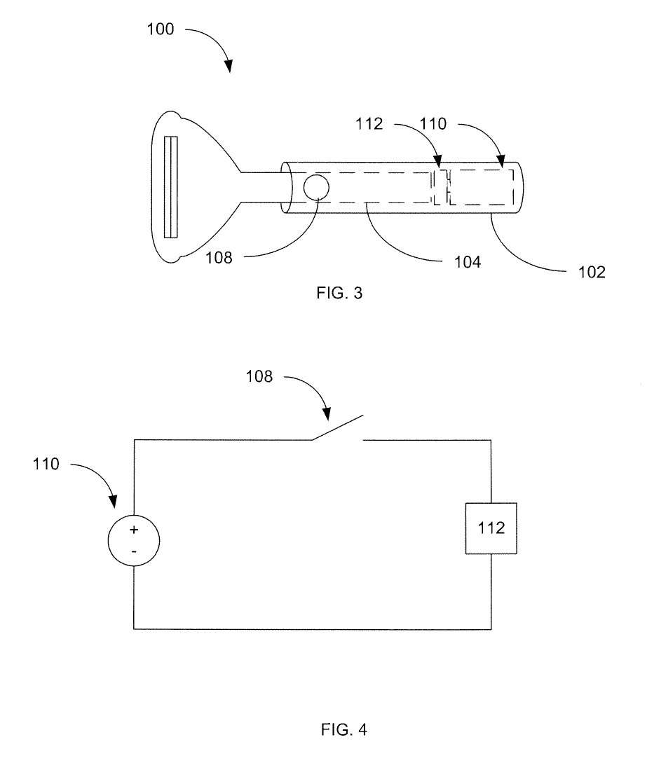

FIG. 3 is a cross sectional view of the apparatus in the exemplary embodiment of FIG. 1. As illustrated in FIG. 3, apparatus 102 may include a button 108 for activating the apparatus. In an exemplary embodiment apparatus 102 may have an outer portion and an interior portion. The interior portion may include a power source 110 such as a battery, wall adapted unit or any other power source to drive a vibratory device 112. Moreover, some embodiments may utilize a renewable power source in order to effectuate the vibratory effect to the handle which may be placed over the existing handle of the disposable razor device.

Another exemplary embodiment may include an apparatus 102 that may be adapted for use with straight edge razor 104 whereby the apparatus 102 may include a small motor adapted to perform the function of vibrating the apparatus when the unit is in the on position.

In yet another exemplary embodiment of the present invention, an apparatus 102 may be provided whereby the apparatus 102 may have an interior portion whereby the interior portion comprises an opening adapted to releasably attach to the handle of a shaving apparatus and may be releasable via a disconnect button on the outer portion of the apparatus.

FIG. 4 is an illustration of an example circuit in an exemplary embodiment of the present invention. Power source 110, which may be a battery, wall adapted unit or any other power source, may be coupled to a vibratory device 112 through a switch 108. In this way, power source 110 may be used to power a vibratory device 112. For example, a vibratory device 112 may be a motor. The motor might be activated by switch 108 which can connect power source 110 to the motor.

It will be understood that the circuit diagram of FIG. 4 is one example. Other embodiments may include additional circuitry or different circuitry all together. For example, in another embodiment, multiple power sources might be used. Other circuitry that might include a switch one source out for another when such a source is available. For example, an embodiment might operate from a battery but switch to a wall adapted unit when power is available from such a unit. Accordingly, it will be understood that the circuit diagram of FIG. 4 is a simplified example and many other possible circuits will occur to those of skill in the art.

In another exemplary embodiment of the present invention, an apparatus may be provided wherein the apparatus may be adaptable for use with a plurality of other prior art disposable devices including toothbrushes, flossing apparatus and even hair brushes.

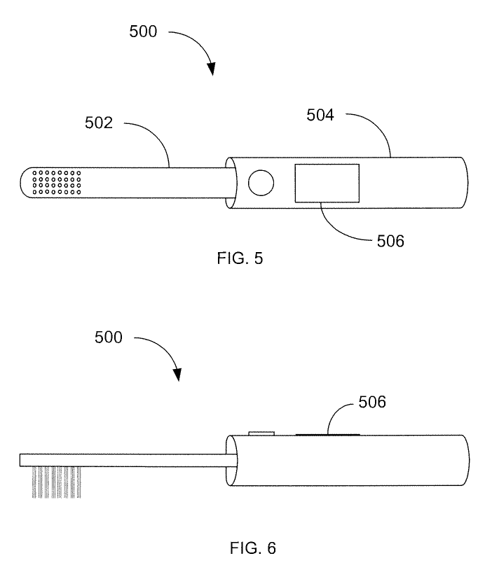

For example, FIGS. 5 and 6 are perspective views illustrating an apparatus 504 in another exemplary embodiment. As illustrated, apparatus 504 is configured to receive a toothbrush 502. In this way, toothbrush 502 may perform the functions of a vibrating toothbrush.

For example, an embodiment may include an apparatus for use in conjunction with a hygienic device. The apparatus can include at least an outside portion and an interior portion, contained by the outside portion. The interior portion may have an opening thereon. The opening may be configured to receive a hygienic device, such as the toothbrush illustrated in FIGS. 5 and 6. Additionally, a vibratory device can be coupled to the interior portion and configured to cause the apparatus to vibrate.

Additionally, some embodiments may include a timer. For example, some apparatus 504 may have a timer which buzzes or briefly interrupts power. For example, this might occur after two minutes and/or every 30 seconds. This may match recommendations to brush for two minutes, 30 seconds for each of the four quadrants of the mouth. Further, some embodiments might include an LCD screen 506 which show brushing time and/or images to encourage optimal brushing. Timers, LCD screens, or both might also be used in conjunction with other embodiments, such as apparatus 102 discussed above.

In some embodiments, the vibrating portion, power source, wiring, circuitry, etc. may be contained within the device and sealed such that water cannot get into these portions of the device. In other words, portions of the device might be water proof or at least water resistant. This may be especially important for use with razors and toothbrushes, which may be rinsed off using water from time to time. Additionally, other hygienic devices might be rinsed or otherwise used in conjunction with water. Accordingly, it may be important to provide a waterproof or water resistant apparatus for other hygienic applications.

Other embodiments include a method for personal hygiene. Such a method can include the step of providing an apparatus for use in conjunction with a hygienic device. The apparatus may be designed as described herein. For example, such a device may include at least an outside portion and an interior portion, contained by the outside portion. Additionally, the interior portion may have an opening thereon, the opening configured to receive a hygienic device. A vibratory device may be coupled to the interior portion and configured to cause the apparatus to vibrate. The example method may also include the step of providing a hygienic device releasably attached to the apparatus by inserting the hygienic device into the interior portion of the apparatus.

Some embodiments of the systems and methods described herein might run on low voltage, 12v or less. As discussed above, some devices may use a battery or a step-down transformer to power the apparatus. Additionally, some apparatus might use a rechargeable battery located in the handle. Some embodiments might use metal tabs to connect with the charging base, while other embodiments might use contactless inductive charging. Contactless inductive charging may provide further protection from water damage because such a setup may eliminate areas where metal contacts might otherwise be required to run through the device to reach the rechargeable battery.

Various objects, features, aspects and advantages of the present invention will become more apparent from the following detailed description of preferred embodiments of the invention, along with the accompanying drawings in which like numerals represent like components.

What is claimed is:

1. An apparatus for use in conjunction with a hygienic device, the apparatus comprising:
at least an outside portion;
an interior portion, contained by the outside portion, whereby the interior portion may have an opening thereon, the opening configured to receive a hygienic device; and
a vibratory device, coupled to the interior portion and configured to cause the apparatus to vibrate.

2. The apparatus described in claim 1 wherein said outside portion is configured to allow for handling by the individual.

3. The apparatus described in claim 1 wherein said outside portion is constructed of a foam material.

4. The apparatus described in claim 1 wherein said outside portion is constructed of plastic.

5. The apparatus described in claim 1 wherein said interior portion has an opening thereon for receiving the handle of a straight edge shaving device.

6. The apparatus described in claim 1 wherein said interior portion has a power means contained therein.

7. The apparatus described in claim 1 wherein said interior portion has a renewable power source whereby the power source is a battery.

8. The apparatus described in claim 1 wherein the apparatus may have a button contained thereon to turn the apparatus on and off.

9. The apparatus described in claim 1 wherein the vibratory apparatus device includes a motor whereby when activated, the motor causes vibration of the apparatus which in turn causes vibration of a hygienic device when said hygienic device is attached to the apparatus by insertion into the interior portion of the apparatus.

10. The apparatus described in claim 1 wherein the apparatus may be releasably attached to a hygienic device and whereby a button may be contained on the outside portion to allow for release and adaption of the hygienic device to the apparatus.

11. A hygienic system comprising:
an apparatus for use in conjunction with a hygienic device, the apparatus including:
at least an outside portion;
an interior portion, contained by the outside portion, whereby the interior portion may have an opening thereon, the opening configured to receive a hygienic device; and
a vibratory device, coupled to the interior portion and configured to cause the apparatus to vibrate.
a hygienic device releasably attached to the apparatus by inserting the hygienic device into the interior portion of the apparatus.

12. The hygienic system of claim 11 wherein the hygienic device comprises a straight edge razor.

13. The hygienic system of claim 11 wherein the hygienic device comprises a toothbrush.

14. The hygienic system of claim 11 wherein the hygienic device comprises a flossing apparatus.

15. The hygienic system of claim 11 wherein the hygienic device comprises a hair brush.

16. A method for personal hygiene comprising:
providing an apparatus for use in conjunction with a hygienic device, the apparatus including:
at least an outside portion;
an interior portion, contained by the outside portion, whereby the interior portion may have an opening thereon, the opening configured to receive a hygienic device; and
a vibratory device, coupled to the interior portion and configured to cause the apparatus to vibrate.
providing a hygienic device releasably attached to the apparatus by inserting the hygienic device into the interior portion of the apparatus.

17. The method of claim 16 wherein the hygienic device comprises a straight edge razor, the method further comprising shaving using a hygienic system that includes the apparatus and the hygienic device.

18. The method of claim 16 wherein the hygienic device comprises a toothbrush, the method further comprising brushing teeth using a hygienic system that includes the apparatus and the hygienic device.

19. The method of claim 16 wherein the hygienic device comprises a flossing apparatus, the method further comprising flossing using a hygienic system that includes the apparatus and the hygienic device.

20. The method of claim 16 wherein the hygienic device comprises a hair brush, the method further comprising brushing using a hygienic system that includes the apparatus and the hygienic device.
